(19) United States
(12) Patent Application Publication
(10) Pub. No.: US 2026/0201102 A1
(43) Pub. Date: Jul. 16, 2026

(54) BIOBASED POLYESTER POLYOL AND POLYURETHANE FOAM SYSTEM CONTAINING THE SAME

(71) Applicant: BASF SE, Ludwigshafen am Rhein (DE)

(72) Inventors: Jian Feng XU, Shanghai (CN); Zu Bao NIE, Shanghai (CN)

(73) Assignee: BASF SE, Ludwigshafen am Rhein (DE)

(21) Appl. No.: 19/136,534

(22) PCT Filed: Nov. 22, 2023
(86) PCT No.: PCT/EP2023/082653

§ 371 Date: Jun. 6, 2025

(30) Foreign Application Priority Data
Dec. 9, 2022 (WO) PCT/CN2022/137910

(51) Int. Cl. C08G 18/42; C08G 63/16

(52) U.S. Cl. CPC C08G 18/4238; C08G 63/16; C08G 2110/0083

(57) ABSTRACT

In one aspect, a polyester polyol, includes a condensation product of a biobased C7-C12 dicarboxylic acid, a biobased C2-C10 diol, and a branched diol having a formula of (I) where R1 and R2 are independently a linear alkylene linkage having 1 to 3 carbon atoms, and R3 and R4 are independently an alkyl group having 1 to 3 carbon atoms, and wherein the weight ratio of the biobased C2-C10 diol to the branched diol is (25-53) to (47-75). Also provided is a polyurethane system comprising the polyester polyol and a process of preparing the polyester polyol.

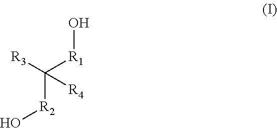

### TECHNICAL FIELD

The present disclosure relates to a biobased polyester polyol, a polyurethane system containing the same, and a process of preparing the same.

### BACKGROUND

Polyurethane (PU) foams are suitable for many applications, for example cushioning materials, thermal insulation materials, packaging, automobile-dashboards, or construction materials.

In most cases a polyurethane foam with good performances such as hydrolysis resistance and mechanical strength is desired. Meanwhile, polymers are expected to be more and more biobased by the requirement of sustainability.

CN112142960A describes a hydrophobic polyester polyol and a polyurethane elastomer based on the same. The polyester polyol is prepared by polymerizing long chain diacid and a diol. The diol is a branched diol or a mixture of a branched diol and a linear diol.

CN109180915A discloses a liquid polyester polyol for polyurethane coating, which is based on the raw materials of a mixture of diacids and a mixture of small molecule diols. The mixture of diacids is a mixture of by-products of adipic acid production.

Biobased raw materials for polyurethane production include castor oil, biobased poly(tetrahydrofuran ether) (biobased pTHF), and biobased polyester polyol. Usually, the dosage of castor oil in the polyol component cannot be high, otherwise curing of the polyurethane system, and the cold flex or adhesion strength of the resulted polyurethane products will be not good. Biobased pTHF is very expensive and scarce in the market. Furthermore, a high content of commercially available biobased polyester polyol usually leads to poor hydrolysis performance of polyurethane, which limits the applications of the products.

### SUMMARY

An objective of the present disclosure is to provide a biobased polyester polyol for producing polyurethane foam. The polyester polyol is based on biobased diols and biobased diacid and provide an alternative to the traditional petroleum-based polyester polyols. The biobased content of the polyester polyol is high.

Surprisingly, it has been found that the above object can be achieved by a polyester polyol which comprises the product of:
a biobased C7-C12 dicarboxylic acid;
a biobased C2-C10 diol; and
a branched diol having a formula of:

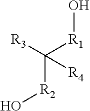

wherein R1 and R2 are independently a linear alkylene linkage having 1 to 3 carbon atoms, and R3 and R4 are independently an alkyl group having 1 to 3 carbon atoms, and wherein the weight ratio of the biobased C2-C10 diol to the branched diol is (25-53) to (47-75).

According to another aspect of the present disclosure, provided is a polyurethane system comprising:
a polyol component; and
an isocyanate component,
wherein the polyol component comprises
the polyester polyol; and
one or more catalysts.

According to another aspect of the present disclosure, provided is a process of preparing a polyester polyol comprising:
in a reaction vessel, mixing a biobased C7-C12 dicarboxylic acid, a biobased C2-C10 diol, and a branched diol, and obtaining a mixture;
heating the mixture at a first temperature in a range of 180° C. to 250° C. for a first duration of time;
heating the crude product at a second temperature in a range of 100° C. to 150° C. for a second duration of time in a range of 1 to 4 hours; and
isolating a polyester polyol from the crude product after the step (c), wherein the branched diol has a formula of:

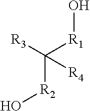

R1 and R2 are independently a linear alkylene linkage having 1 to 3 carbon atoms, and R3 and R4 are independently an alkyl group having 1 to 3 carbon atoms.

It has been surprisingly found in this application that the polyester polyol provided is processable for polyurethane compositions. The polyurethane foam produced therefrom has a high mechanical strength and a resistance to aging.

### DETAILED DESCRIPTION

Unless defined otherwise, all technical and scientific terms used herein have the meaning commonly understood by a person skilled in the art to which the present disclosure belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

The term “biobased” refers to “composed or derived in whole or in part of biological products issued from the biomass (including plant, animal, and marine or forestry materials”. The use of a biobased (e.g., vegetable or animal) precursor or starting material also results in the production of a corresponding biobased monomer/polymer/copolymer of vegetable or animal origin.

The term “biobased content” refers to the fraction of a product derived from renewable biomass, expressed as a percentage of the total mass of the product, determined by testing representative samples using the EN 16785-1 standard.

The term “biobased C2-C10 diol” refers to any C2-C10 diol that is biobased.

The term “biobased C7-C12 dicarboxylic acid” refers to any C7-C12 dicarboxylic acid that is biobased.

The term “branched diol” refers to a diol having at least one substituted alkyl, alkenyl, or alkynyl side group in its main chain that is terminated by the two hydroxyl groups.

The term “linear diol” refers to any diol having no side group in its main chain that is directly terminated by the two hydroxyl groups.

The term “alkyl” refers to a saturated linear, branched or cyclic hydrocarbon radicals having generally from 1 to 36 carbon atoms, for example, methyl, ethyl, propyl, 1-methylethyl (isopropyl), butyl, 1-methylpropyl (sec-butyl), 2-methylpropyl (isobutyl), 1,1-dimethylethyl (tert-butyl), pentyl, 1-methylbutyl, 2-methylbutyl, 3-methylbutyl, 2,2-dimethylpropyl, 1-ethylpropyl, cyclopentyl, hexyl, 1-methylpentyl, n-heptyl, n-octyl, 2-ethylhexyl, n-nonyl, n-decyl, 1-methylnonyl, 2-propylheptyl, n-dodecyl, 1-methyldodecyl, n-tridecyl, n-tetradecyl, n-pentadecyl, n-hexadecyl, n-heptadecyl, n-octadecyl, n-nonadecyl, n-eicosyl, and the like.

The term “alkylene” refers to a divalent straight-chain or branched hydrocarbon radical having generally 1 to 36 carbon atoms, for example, ethane-1,2-diyl, propane-1,3-diyl, propane-1,2-diyl, 2-methylpropane-1,2-diyl, butane-1,4-diyl, butane-1,3-diyl (=1-methylpropane-1,3-diyl), butane-1,2-diyl and butane-2,3-diyl.

The term “carboxyl” or “carboxylic group” refers to the functional group (—C(O)OH) as in organic carboxylic acids such as acetic acid.

The term “hydroxyl number” refers to the mass of potassium hydroxide (KOH) in milligrams that is required to neutralize the acetic acid taken up on acetylation of one gram of a polyol or a blend of polyols. The hydroxyl number is determined in accordance with Deutsches Institut für Normung (DIN) 53240 from 2012 and refers to mgKOH/g.

The term “acid number” refers to the mass of potassium hydroxide (KOH) in milligrams that is required to neutralize the acidic groups in one gram of a polyol or a blend of polyols. The acid number is determined by Deutsches Institut für Normung (DIN) EN 12634 (DIN standard of the Deutsches Institut fur Normung e.V.) from 1999 and refers to mgKOH/g.

The term “functionality” of a polyol refers to the number of hydroxyl groups per polyol molecule. Functionality of a blend of several polyols refers to the molar average of the functionality of all the component polyols.

The term “isocyanate index” or “NCO index” of a polyurethane system refers to the ratio of number of NCO groups over number of isocyanate-reactive hydrogen atoms present in the polyurethane system, given as a percentage:

$$Isocyanate index = \frac{[ NCO ]}{[ Isocyanate - reactive hydrogen ]} \times 100 \%$$

[NCO] is the number of NCO groups.
[isocyanate-reactive hydrogen] is the number of isocyanate-reactive hydrogen atoms.

In other words, the isocyanate index expresses the percentage of isocyanate actually used in a formulation with respect to the amount of isocyanate theoretically required for reacting with the amount of isocyanate-reactive hydrogen used in a formulation.

Unless otherwise identified, the temperature refers to room temperature and the pressure refers to ambient pressure.

Unless otherwise identified, the solvent refers to all organic and inorganic solvents known to the person skilled in the art and does not include any type of monomer molecular.

### Polyester Polyol

The polyester polyol in the present disclosure comprises a condensation product of:
a biobased C7-C12 dicarboxylic acid;
a biobased C2-C10 diol; and
a branched diol having a formula of:

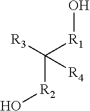

wherein R1 and R2 are independently a linear alkylene linkage having 1 to 3 carbon atoms, and R3 and R4 are independently an alkyl group having 1 to 3 carbon atoms, and wherein the weight ratio of the biobased C2-C10 diol to the branched diol is (25-53) to (47-75).

The condensation product is obtained by esterification of the biobased C2-C10 diol and the branched diol by the biobased C7-C12 dicarboxylic acid. Carboxylic groups present in the biobased C7-C12 dicarboxylic acid react with hydroxyl groups present in the biobased C2-C10 diol and the branched diol under elevated temperature, forming ester linkages with water as by product. The condensation may take place in an elevated temperature under a protective atmosphere, such as, a nitrogen or any other inert gas atmosphere, optionally in the presence of a catalyst.

Preferably, the biobased C7-C12 dicarboxylic acid is suberic acid, azelaic acid, sebacic acid, dodecanedioic acid, cyclohexanedicarboxylic acid, terephthalic acid, or any mixture thereof.

An exemplary biobased C7-C12 dicarboxylic acid is sebacic acid, which may be produced from castor oil by cleavage of ricinoleic acid. Another example, cyclohexanedicarboxylic acid, can be produced by catalytic hydrogenation of biobased terephthalic acid, which is available by Virent, Inc., Gevo, Inc., Anellotach, Inc., or Micromidas, Inc.

The sources and routes to prepare or obtain such biobased C7-C12 dicarboxylic acid are known. The sources may be both naturally occurring and genetically modified organism, including plants, animals, or microorganisms.

Preferably, the biobased C2-C10 diol includes at least one linear diol, preferably at least one linear diol selected from the group consisting of 1,3-propanediol, trans-2-butene-1,4-diol, 1,4-butanediol, 1,5-pentanediol, 1,6-hexanediol, and 1,10-decanediol.

A commonly used method to prepare such linear diol is hydrogenation of the corresponding biobased linear C2-C10 dicarboxylic acid and/or its alkyl ester in the presence of catalyst, such as Raney nickel, under an elevated pressure. Another method is reduction of the same under a reducing agent such as boron hydride, lithium aluminum hydride, diisobutylaluminum hydride. An especially exemplary biobased C2-C10 diol is 1,3-propanediol, which is obtainable through biosynthesis conducted by certain microorganisms starting from glucose or glycerol. Another example of biobased C2-C10 diols is 1,4-butanediol, which may be obtained through biosynthesis starting from 4-hydroxybutyrate by a genetically modified organism. Still another example of biobased C2-C10 diols is 1,10-decanediol, which may be obtained through hydrogenation of sebacic acid, which may be generated from treating castor oil with alkali hydroxide under heating.

Preferably, the biobased C2-C10 diol includes a cyclic diol, preferably at least one of isosorbide and tetrahydrofuran-2,5-dimethanol. In one embodiment, the biobased C2-C10 diol includes isosorbide. In one embodiment, the biobased C2-C10 diol includes tetrahydrofuran-2,5-dimethanol. In one embodiment, the biobased C2-C10 diol includes isosorbide and tetrahydrofuran-2,5-dimethanol.

Branched diols according to the present disclosure are represented by the following formula:

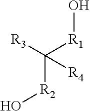

wherein R1 and R2 are independently a linear alkylene linkage having 1 to 3 carbon atoms, and R3 and R4 are independently an alkyl group having 1 to 3 carbon atoms.

Preferably, the branched diol is neopentyl glycol, methyl propanediol, 2-ethyl-1,3-propanediol, 2,2,4-trimethylpentane-1,3-diol, or any mixture thereof. In one embodiment, the branched diol includes neopentyl glycol. In one embodiment, the branched diol includes methyl propanediol. In one embodiment, the branched diol includes 2-ethyl-1,3-propanediol. In one embodiment, the branched diol includes 2,2,4-trimethylpentane-1,3-diol. In one embodiment, the branched diol includes neopentyl glycol and methyl propanediol. In one embodiment, the branched diol includes neopentyl glycol and 2-ethyl-1,3-propanediol. In one embodiment, the branched diol includes neopentyl glycol and 2,2,4-trimethylpentane-1,3-diol. In one embodiment, the branched diol includes methyl propanediol and 2-ethyl-1,3-propanediol. In one embodiment, the branched diol includes methyl propanediol and 2,2,4-trimethylpentane-1,3-diol. In one embodiment, the branched diol includes 2-ethyl-1,3-propanediol and 2,2,4-trimethylpentane-1,3-diol. In one embodiment, the branched diol includes neopentyl glycol, methyl propanediol, and 2-ethyl-1,3-propanediol. In one embodiment, the branched diol includes neopentyl glycol, methyl propanediol, and 2,2,4-trimethylpentane-1,3-diol. In one embodiment, the branched diol includes neopentyl glycol, 2-ethyl-1,3-propanediol, and 2,2,4-trimethylpentane-1,3-diol. In one embodiment, the branched diol includes methyl propanediol, 2-ethyl-1,3-propanediol, and 2,2,4-trimethylpentane-1,3-diol. In one embodiment, the branched diol includes neopentyl glycol, methyl propanediol, 2-ethyl-1,3-propanediol, and 2,2,4-trimethylpentane-1,3-diol.

In some embodiments, the branched diol may also be derived from biomass, i.e., the branched diol is biobased. For example, there have been commercially available neopentyl glycol that is biobased.

Preferably, the polyester polyol has a number average molecular weight of 1,000 to 3,000 g/mol.

Preferably, the molar ratio of carboxylic groups in the biobased C7-C12 dicarboxylic acid and hydroxyl groups in both the biobased C2-C10 diol and the branched diol is 1:(1.02-1.20). The excess of hydroxyl groups vis-a-vis carboxylic groups results in hydroxyl termination of the polyester polyol of the present disclosure.

Preferably, the polyester polyol has a viscosity under 25° C. of 8,000 mPas to 13,000 mPas measured according to DIN EN 3219.

Being a condensation product of several biobased raw materials, the polyester polyol according to the present disclosure may have a high biobased content. Preferably, the polyester polyol has a biobased content higher than 60 wt. %, more preferably higher than 65 wt. %, further preferably higher than 70 wt. %, further more preferably higher than 75 wt. %, still further more preferably 80 wt. %, according to the EN 16785-1 standard.

The present disclosure also provides a process of preparing a polyester polyol including:
a. in a reaction vessel, mixing a biobased C7-C12 dicarboxylic acid, a biobased C2-C10 diol, and a branched diol, and obtaining a mixture;
b. heating the mixture at a first temperature in a range of 180° C. to 250° C. for a first duration of time;
c. continuing the heating to obtain a crude product under a sub-atmospheric pressure inside the reaction vessel;
d. heating the crude product at a second temperature in a range of 100° C. to 150° C. for a second duration of time in a range of 1 to 4 hours and removing one or more volatile impurities; and
e. isolating a polyester polyol from the crude product after the step (d), wherein the branched diol has a formula of:

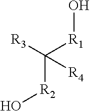

R1 and R2 are independently a linear alkylene linkage having 1 to 3 carbon atoms, and R3 and R4 are independently an alkyl group having 1 to 3 carbon atoms.

The process employs condensation of the above reactants to form polyester polyol of the present disclosure.

The reaction vessel may have a protective atmosphere inside. Preferably, the protective atmosphere is an atmosphere with reduced oxygen content, a nitrogen atmosphere, or any other inert atmosphere. Using the protective atmosphere inside the reaction vessel may reduce the side reaction caused by oxygen in the ambient environment and improve the color of polyester polyol obtained from the process.

Preferably, in step (b), the mixture is heated at the first temperature in a range of 200° C. to 240° C. The heating may be accompanied by purging nitrogen or other inert gas to facilitate removal of water as product of the condensation reaction.

Preferably, the sub-atmospheric pressure is within a range of 5 mbar to 0.8 bar, more preferably a range of 10 mbar to 0.5 bar.

Preferably, the first duration of time is from 1 to 6 hours, more preferably from 2 to 5 hours.

When the crude product is heated at a temperature lower than the first temperature, the esterification reaction may substantially cease. The heating may remove one or more impurities, which often are sources of volatile organic compounds (VOCs), without causing side reactions. The isolated polyester polyol in step (e) may have a low content of VOCs, which is desirable in various applications such as smart wearable products, personal devices, home appliance, automotive components, or furniture.

### Polyurethane System

To prepare a polyurethane foam or compact polyurethane, a polyurethane system is provided. In various embodiments, the polyurethane system comprises a polyol component and an isocyanate component, wherein the polyol component comprises:
the polyester polyol according to the present disclosure; and
one or more catalysts.

Preferably, the polyurethane system further comprises a blowing agent.

Preferably, the polyol component and the isocyanate component are in a weight ratio of such that the isocyanate index is from 80% to 500%, preferably from 90% to 450%, more preferably from 100% to 150%.

Preparation of the polyurethane basically involves reaction of polyol and a catalyst with an isocyanate optionally in the presence of chain extenders, blowing agents, and/or other additives.

### Polyol Component

The polyol component comprises the polyester polyol according to the present disclosure; and one or more catalysts.

Preferably, the polyester polyol has a weight percentage of 50 wt. % to 100 wt. %, preferably 60 wt. % to 95 wt. %, more preferably 70 wt. % to 80 wt. %, based on a total weight of the polyol component.

Optionally, the polyol component may further comprise a chain extender or crosslinking agent; a blowing agent; and one or more additives and/or auxiliaries.

### Other Polyester Polyols, Polyether Polyols, and Polycarbonate Polyol

In further embodiments, the polyester polyol provided in the present disclosure could be used in combination with other polyols. The other polyols include other polyester polyols, polyether polyol, or polycarbonate polyols.

Polyester polyols, polycarbonate polyols, and polyether polyols are collectively known as polyols. Polyol refers to a polyhydroxy compound. Preferably, polyhydroxy compounds having a functionality of 2 to 8, more preferably 2 to 3, and a hydroxyl number of 150 to 850 mg KOH/g, more preferably 200 to 600 mg KOH/g are examples of higher molecular weight compounds having at least two isocyanate-reactive hydrogen atoms. In addition, mixtures of at least two of the aforesaid polyhydroxy compounds can be used as long as these have an average hydroxyl number in the aforesaid range. The polyol other than the biobased polyester polyol according to the present disclosure may be used either individually or in the form of mixtures.

Polyester polyols can be produced, for example, from organic dicarboxylic acids with 2 to 12 carbons, preferably aliphatic dicarboxylic acids with 4 to 6 carbons, and multivalent alcohols, preferably diols, with 2 to 12 carbons, preferably 2 to 6 carbons. Examples of dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids can be used individually or in mixtures. Instead of the free dicarboxylic acids, the corresponding dicarboxylic acid derivatives may also be used such as dicarboxylic acid mono- or di-esters of alcohols with 1 to 4 carbons, or dicarboxylic acid anhydrides. Dicarboxylic acid mixtures of succinic acid, glutaric acid and adipic acid in quantity ratios of 20-35:35-50:20-32 parts by weight are preferred, especially adipic acid. Examples of divalent and multivalent alcohols, especially diols, include ethanediol, diethylene glycol, 1,2- and 1,3-propanediol, dipropylene glycol, 1,4-butanediol, 1,5-pentanediol, 1,6-hexanediol, 1,10-decanediol, glycerin, and trimethylolpropane. Glycol, diethylene glycol, 1,4-butanediol, 1,5-pentanediol, 1,6-hexanediol, or mixtures of at least two of these diols are preferred, especially mixtures of 1,4-butanediol, 1,5-pentanediol and 1,6-hexanediol.

Polyester polyols can also be produced from an initiator taking the form of a small molecule diol, triol, or higher polyhydroxy alcohol, such as glycol, glycerol, or pentaerythritol, and a polylactone in the presence of a catalyst. The ring-opening reaction results in a polyester polyol. Such polyester polyols include without limitation to polylactide polyol and polycaprolactone polyol.

The polycondensation of organic polycarboxylic acids, e.g., aromatic or preferably aliphatic polycarboxylic acids and/or derivatives thereof and multivalent alcohols may take place in the absence of catalysts or preferably in the presence of esterification catalysts, preferably in an atmosphere of an inert gas, e.g., nitrogen, carbon dioxide, helium, argon, etc., in the melt at temperatures of 150° C. to 250° C., preferably 180° C. to 220° C., optionally under reduced pressure, up to the desired polymerization degree, which is preferably less than 10, especially less than 5. In a preferred embodiment, the esterification mixture is subjected to polycondensation at the temperatures mentioned above up to an acid number of 80 mg/g to 30 mg/g, preferably 40 mg/g to 30 mg/g, under normal pressure and then under a pressure of less than 500 mbar, preferably 50 to 150 mbar. Examples of suitable esterification catalysts include iron, cadmium, cobalt, lead, zinc, antimony, magnesium, titanium and tin catalysts in the form of metals, metal oxides or metal salts. However, the polycondensation may also be per formed in liquid phase in the presence of diluents and/or entraining agents such as benzene, toluene, xylene or chlorobenzene for azeotropic distillation of the water of condensation.

To produce the polyester polyols, the organic polycarboxylic acids and/or derivatives thereof and multi valent alcohols are preferably polycondensed in a mole ratio of 1:1-1.8, preferably 1:1.05-1.2.

Polyether polyols, which can be obtained by known methods, may also be used as the polyhydroxy compounds. For example, polyether polyols can be produced by anionic polymerization with alkali hydroxides such as sodium hydroxide or potassium hydroxide or alkali alcoholates, such as sodium methylate, sodium ethylate or potassium ethylate or potassium isopropylate as catalysts and with the addition of at least one initiator molecule containing 2 to 3 isocyanate-reactive hydrogens or by cationic polymerization with Lewis acids such as antimony pentachloride, boron trifluoride etherate, or bleaching earth as catalysts from one or more alkylene oxides with 2 to 4 carbons in the alkylene radical.

Cyclic ethers and alkylene oxides include, for example, tetrahydrofuran, 1,3-propylene oxide, 1,2- and 2,3-butylene oxide, styrene oxide, and preferably ethylene oxide and 1,2-propylene oxide. The alkylene cyclic ethers and oxides may be used individually, in alternation, one after the other or as a mixture. Examples of initiators include water, multivalent alcohols, organic dicarboxylic acids such as succinic acid, adipic acid, phthalic acid and terephthalic acid, aliphatic and aromatic, optionally N-mono-, N,N-, and N,N′-dialkyl substituted diamines with 1 to 4 carbons in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamines, 2,3-, 2,4- and 2,6-toluenediamine and 4,4′-, 2,4′-, and 2,2′-diaminodiphenylmethane.

Multivalent alcohols, especially divalent, trivalent, and/or tetravalent alcohols are preferred such as ethanediol, 1,2-propanediol and 1,3-propanediol, diethylene glycol, dipropylene glycol, 1,4-butanediol, 1,6-hexanediol, glycerin, trimethylolpropane, erythritol, pentaerythritol, sorbitol, and sucrose.

Initiators may also include alkanolamines such as ethanolamine, diethanolamine, N-methyl- and N-ethyl ethanolamine, N-methyl- and N-ethyl diethanolamine and triethanolamine plus ammonia.

Polycarbonate polyols are hydroxyl group-containing polycarbonates include those obtained by reaction of diols, e.g., 1,3-propanediol, 1,4-butanediol, and/or 1,6-hexanediol, diethylene glycol, triethylene glycol or tetraethylene glycol and diaryl carbonates, e.g., diphenyl carbonate, or phosgene.

### Catalysts

The catalyst used in the present disclosure may include one or more selected from metal-based catalyst and amine-based catalysts. The catalysts can greatly accelerate the reaction of the hydroxyl group containing compounds of components and optionally with the polyisocyanates.

The metal-based catalyst may include an organic tin compound such as tin (II) salts of organic carboxylic acids, e.g., tin (II) acetate, tin (II) octanoate, tin (II) ethylhexanoate and tin (II) laurate, and dialkyltin (IV) salts of organic carboxylic acids, e.g., dibutyltin diacetate, dibutyltin diacetate, dibutyltin dilaurate, dibutyltin maleate, and dioctyltin diacetate. The metal-based catalyst may include a potassium compound selected from a group consisting of potassium hydroxide, potassium carbonate, potassium bicarbonate, potassium benzoate, potassium formate, potassium acetate, potassium propionate, potassium butyrate, potassium valerate, potassium caproate, potassium caprylate, potassium 2-ethylhexanoate, potassium neodecanoate, potassium caprate, potassium salicylate, potassium laurate, potassium oleate, potassium maleate, potassium citrate, potassium oxalate, potassium methoxide, potassium cellulose, potassium carboxymethylcellulose, potassium hyaluronate, potassium alginate, potassium gluconate and any combination thereof.

Examples of the amine-based catalysts may include amines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′N′-tetramethylethylenediamine, N,N,N′,N′-tetraymethylbutanediamine, or -hexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diaza-bicyclo[2.2.-2]octane and alkanolamine compounds such as triethanolamine, triisopropanolamine, N-methyl- and N-ethyldiethanolamine and dimethylethanolamine.

Suitable catalysts include tris-(dialkylamino-s-hexahydrotriazines, especially tris(N,N-dimethylaminopropyl)-s-hexahydrotriazine, tetraalkylammonium hydroxides such as tetramethylammonium hydroxide, alkali hydroxides such as sodium hydroxide and alkali alcoholates such as sodium methylate and potassium isopropylate as well as alkali salts of long chain fatty acids with 10 to 20 carbon atoms and optionally OH dependent groups. A particular catalyst or combination of catalysts may be chosen by the person skilled in the art.

### Chain Extenders and Crosslinking Agents

The polyurethane can be prepared with or without using chain extenders and/or crosslinking agents. Suitable chain extenders and/or crosslinking agents include preferably alkanolamines, more preferably diols and/or triols. One group of examples include alkanolamines such as ethanolamine and/or isopropanolamine; dialkanolamines, such as diethanolamine, N-methyl-, N-ethyldiethanolamine, diisopropanolamine; trialkanolamines such as triethanolamine, triisopropanolamine; and the addition products from ethylene oxide or 1,2-propylene oxide, and alkylenediamines having 2 to 6 carbon atoms in the alkylene radical such as N,N′-tetra(2-hydroxyethyl)-ethylenediamine and N,N′-tetra(2-hydroxypropyl)ethylenediamine. Another group of examples include aliphatic, cycloaliphatic and/or araliphatic diols having 2 to 14, more preferably 4 to 10 carbon atoms such as ethylene glycol, 1,3-propanediol, 1,10-decanediol, o-, m-, p-dihydroxycyclohexane, diethylene glycol, dipropylene glycol, and preferably 1,4-butanediol, 1,6-hexanediol, and bis(2-hydroxyethyl)hydroquinone; triols such as 1,2,4- and 1,3,5-trihydroxycyclohexane, glycerin and trimethylolpropane; and lower molecular weight hydroxyl group containing polyalkylene oxides, based on ethylene oxide and/or 1,2-propylene oxide and aromatic diamines such as toluenediamines and/or diaminodiphenylmethanes as well as the aforesaid alkanolamines, diols, and/or triols as initiator molecules.

### Blowing Agents

Blowing agents which can be used are physical blowing agents and chemical blowing agents.

The compounds known as physical blowing agents can preferably also be used in combination with water or preferably instead of water. These are compounds inert with respect to the starting components, mostly liquid at room temperature, and evaporating under the conditions of the urethane reaction. The boiling point of these compounds is preferably below 500° C. Among the physical blowing agents are also compounds which are gaseous at room temperature and which are introduced or dissolved into the starting components under pressure, examples being carbon dioxide, low-boiling alkanes, and fluoroalkanes.

The physical blowing agents are mostly selected from the group consisting of alkanes and/or cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular, tetramethylsilane. Examples which may be mentioned are propane, n-butane, isobutane, cyclobutane, n-pentane, isopentane, cyclopentane, cyclohexane, dimethyl ether, methyl ethyl ether, methyl butyl ether, methyl formate, acetone, and also fluoroalkanes which can be degraded in the troposphere and therefore do not damage the ozone layer, e.g., trifluoromethane, difluoromethane, 1,1,1,3,3-pentafluorobutane, 1,1,1,3,3-pentafluoropropane, 1,1,1,2-tetrafluoroethane, difluoroethane, and heptafluoropropane. The physical blowing agents mentioned may be used alone or in any desired combinations with one another.

The chemical blowing agents include water, carboxylic acid such as formic acid, and/or carboxyl-terminated oligomers, these reacting with isocyanate groups with elimination of carbon dioxide and, respectively, carbon dioxide and carbon monoxide.

The amount of the blowing agent is from 1 to 55% by weight, preferably from 1 to 40% by weight, particularly preferably from 2 to 30% by weight, and in particular from 5 to 25% by weight, based on the total weight of the polyol component.

In some embodiments, the amount of water is preferred in a range of 0.1 to 5.0% by weight, based on the weight of the polyol component.

### Other Additives

Optionally other additives may be incorporated into the polyol component. Examples include flame retardants, surfactants, foam stabilizers, defoamers, cell regulators, fillers, dyes, pigments, hydrolysis preventing agents, fungistatic and bacteriostatic agents.

Preferably, the flame retardant comprises at least one phosphorus-containing flame retardant which is a derivative of phosphoric acid, polyphosphoric acid, phosphonic acid, and/or phosphinic acid. Flame retardants for the purposes of the present disclosure are preferably liquid organic phosphorus compounds such as halogen-free organic phosphates such as triethyl phosphate (TEP), halogenated phosphates, for example tris (1-chloro-2-propyl) phosphate (TCPP) and tris (2-chloroethyl) phosphate (TCEP), and organic phosphonates such as dimethyl methylphosphonate (DMMP), dimethyl propane phosphonate (DMPP), or solids such as ammonium polyphosphate (APP) and red phosphorus. Furthermore, besides the phosphorus-containing flame retardant, halogenated compounds, for example, halogenated polyols, as well as solids, such as expanded graphite and melamine are suitable as an auxiliary flame retardant.

Examples of surfactants are compounds which serve to support homogenization of the starting materials and may also regulate the cell structure of the plastics. Specific examples are salts of sulfonic acids, e.g., alkali metal salts or ammonium salts of fatty acids such as oleic or stearic acid, of dodecylbenzene- or dinaphthylmethanedisulfonic acid, and ricinoleic acid; foam stabilizers, such as siloxane-oxyalkylene copolymers and other organopolysiloxanes, oxyethylated alkyl-phenols, oxyethylated fatty alcohols, paraffin oils, castor oil esters, ricinoleic acid esters, Turkey red oil and groundnut oil, and cell regulators, such as paraffins, fatty alcohols, and dimethylpolysiloxanes. The surfactants are usually used in amounts of 0.01 to 5 parts by weight, based on 100 parts by weight of the polyol component. Furthermore, the oligomeric acrylates with polyoxyalkylene and fluoroalkane side groups are also suitable for improving the emulsifying effect, the cell structure and/or for stabilizing the foam. These surfactants are generally used in amounts of 0.01 wt. % to 5 wt. % based on the weight of the polyol component.

For example, fillers are conventional organic and inorganic fillers and reinforcing agents. Specific examples are inorganic fillers, such as silicate minerals, for example, phyllosilicates such as antigorite, serpentine, hornblendes, amphiboles, chrysotile, and talc; metal oxides, such as kaolin, aluminum oxides, titanium oxides and iron oxides; metal salts, such as chalk, baryte and inorganic pigments, such as cadmium sulfide, zinc sulfide and glass, inter alia; kaolin (china clay), aluminum silicate and coprecipitates of barium sulfate and aluminum silicate, and natural and synthetic fibrous minerals, such as wollastonite, metal, and glass fibers of various lengths. Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers. The inorganic and organic fillers may be used individually or as mixtures and may be introduced into the polyol component or isocyanate side in amounts of from 0.5 to 40 percent by weight, based on the weight of components (the polyols and the isocyanate).

### Isocyanate Component

The isocyanate component in the present disclosure comprises one or more selected from the group consisting of aliphatic, cycloaliphatic, araliphatic, and aromatic isocyanates. For example, the isocyanate component may include alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures and preferably aromatic diisocyanates and polyisocyanates such as 2,4- and 2,6-toluene diisocyanate (TDI) and the corresponding isomeric mixtures, 4,4′-, 2,4′-, and 2,2′-diphenylmethane diisocyanate and the corresponding isomeric mixtures, mixtures of 4,4′-, 2,4′-, and 2,2′-diphenylmethane diisocyanates (MDI) and polyphenylenepolymethylene polyisocyanates (polymeric MDI), as well as mixtures of polymeric MDI and toluene diisocyanates. The organic di- and polyisocyanates can be used individually or in the form of mixtures. Preferably, the isocyanate component comprises monomeric and/or polymeric methylene diphenyl diisocyanate in a percentage of not less than 90 wt. %.

### Foams and Elastomers

According to the present disclosure, a polyurethane foam or elastomer may be produced from the polyol component and the isocyanate component.

The polyurethane foams can be prepared with the help of conventional mixing equipment.

It should be observed that the isocyanate index as used herein is considered from the point of view of the actual foaming process involving the isocyanate ingredients and the isocyanate-reactive ingredients. Any isocyanate groups consumed in a preliminary step to produce modified polyisocyanates (including such isocyanate-derivatives referred to in the art as prepolymers) or any isocyanate-reactive hydrogens consumed in a preliminary step (e.g., reacted with isocyanate to produce modified polyols or polyamines) are not taken into account in the calculation of the isocyanate index. Only the free isocyanate groups and the free isocyanate-reactive hydrogens (including those of the water) present at the actual foaming process are taken into account.

The polyurethane foam may also find applications in furniture, packaging materials, synthetic leathers, bumpers, mattresses, cushions, automotive seating, footwears, cleansing articles, thermal insulating boards or panels in cleanroom or cold storage, sandwich panel, waterproof panels or boards in construction roofs.

In some scenarios, the polyurethane foam according to the present disclosure may be included in a composite. The composite may be a sandwich panel. The sandwich panel may include the polyurethane foam as its core layer. The sandwich panel may include metal layer as outer layer(s).

The polyurethane elastomer may find applications in coatings, protective materials, cushioning, sealings, bearings, wheels, or belts.

### EXAMPLES

The materials used in the examples are as follows.
Sebacic acid, from BASF, CAS No. 111-20-6.
1,3-propanediol, “PDO”, a linear diol from BASF, CAS No. 504-63-2.
Neopentyl glycol, “NPG”, a branched diol from BASF, CAS No. 126-30-7.
Ethylene glycol, used as chain extender in polyol component, from BASF, CAS No. 107-21-1.
4,4′-diphenylmethane diisocyanate (MDI) from BASF, CAS No. 101-68-8.
PESOL 2 is a polyester polyol with a functionality of 2 and a hydroxy number of 56 mgKOH/g.
Dabco® EG, 33 wt. % triethylenediamine (CAS No. 280-57-9) dissolved in ethylene glycol from Evonik, used as catalyst.

### Synthesis of Polyester Polyols

The chemical pathway to synthesize the polyester polyol according to the present disclosure is an esterification of a biobased C7-C12 dicarboxylic acid and a mixture of a biobased C2-C10 diol and a branched diol. The synthesis may follow a one-pot approach.

In a typical one-pot approach, biobased sebacic acid was mixed with biobased 1,3-propanediol and neopentyl glycol. The mixing gave a paste like mixture. The mixture was placed within a flask. No catalyst was added. However, a minor amount of catalyst such as tetrabutyl titanate may be added to accelerate the esterification or lower the reaction temperature. The flask was fitted with a column and a condenser to collect the condensation product. During the synthesis, the setup was continuously flushed with nitrogen or other inert gas to limit oxidation and facilitate transport of water vapor out of the reaction system. While stirring, the mixture was heated to 230° C., using a heating device. The heating continued for ten (10) hours. The reaction temperature increased stepwise to maintain distillation of the formed by-products. The water obtained from the esterification was removed in situ.

When the collected distilled water reached about 80% of the theoretical amount of water as product of esterification, the flask was depressurized to 20 mbar. The heating continued and lasted for ten (10) hours. After the acid number of the mixture was lower than 2.0 mg/g, the mixture was allowed to cool to 120° C. The temperature of mixture was kept at 120° C. for another four (4) hours. The pressure remained at 20 mbar.

After the synthesis, the hydroxy numbers and viscosity values were measured. The hydroxy numbers were determined by titration. The viscosity values were tested under 25° C. measured according to DIN EN 3219. The final acid number of the product was less than 1.0 mg/g.

In the as-made product, the content of cyclic oligomers formed by the reaction of sebacic acid and 1,3-propanediol was less than 50 ppm, which was confirmed by liquid chromatography mass spectroscopy analysis. The cyclic oligomers may be in the form of lactones.

In the below table, “PO” refers to polyester polyols according to the present disclosure, while “CPO” refers to comparative polyester polyols.

TABLE 1
Raw materials for preparing polyester polyols

| | PO 1 | PO 2 | CPO 1 | CPO 2 |
|---|---|---|---|---|
| Sebacic acid, g | 606 | 606 | 606 | 606 |
| 1,3-propanediol, g | 125.4 | 159.6 | 186.2 | 64.6 |
| Neopentyl glycol, g | 182 | 135.2 | 98.8 | 265.2 |
| NPG/(PDO + NPG) | 59.2% | 45.9% | 34.7% | 80.4% |
| (wt./wt.) | | | | |
| Hydroxyl number, | 56 | 57 | 57 | 57 |
| mgKOH/g | | | | |
| Number average Mw, | ca. 2,000 | ca. 2,000 | ca. 2,000 | ca. 2,000 |
| g/mol | | | | |
| Viscosity, mPa s | 10,500 | 12,000 | 15,500 | 6,300 |
| Functionality | 2 | 2 | 2 | 2 |

In Table 2, “PF” refers to samples made from polyester polyols according to the present disclosure, while “CPF” refers to samples made from comparative polyester polyols.

TABLE 2
Compositions of polyurethane systems

| | PF 1 | PF 2 | CPF 1 | CPF 2 |
|---|---|---|---|---|
| Component A | | | | |
| PO 1, g | 100 | — | — | — |
| PO 2, g | — | 100 | — | — |
| CPO 1, g | — | — | 100 | — |
| CPO 2, g | — | — | — | 100 |
| Ethylene glycol, g | 11.5 | 11.5 | 11.5 | 11.5 |
| DABCO EG, g | 1 | 1 | 1 | 1 |
| Water, g | 0.25 | 0.25 | 0.25 | 0.25 |
| Component B | | | | |
| MS (pMDI), g | 60 | 60 | 60 | 60 |
| PESOL 2, g | 40 | 40 | 40 | 40 |
| NCO, wt. % | 18.5 | 18.5 | 18.5 | 18.5 |
| Isocyanate index | 100 | 100 | 100 | 100 |

The polyurethane systems were made into elastomer samples. The samples all had a molded density of 600 kg/m³. The samples had their tensile strengths tested according to 5 DIN 53504. To evaluate the anti-aging properties, the samples were placed in an environmental test chamber where the temperature and the relative humidity were set to be 70° C. and 95%, respectively.

TABLE 3
Performances of samples prepared from the polyurethane systems

| | | PF 1 | PF 2 | CPF 1 | CPF 2 |
|---|---|---|---|---|---|
| Molded density, kg/m³ | | 600 | 600 | 600 | 600 |
| Tensile strength, MPa | | 2.4 | 2.7 | 3.0 | 1.9 |
| Tensile strength, MPa | 1 week | 2.5 | 2.7 | 3.0 | 1.9 |
| Under 70° C., 95% RH | 2 weeks | 2.3 | 2.4 | 1.5 | 1.7 |
| aging, after | 3 weeks | 2.0 | 2.0 | 1.0 | 1.5 |
| | 5 weeks | 1.5 | 1.2 | 0.5 | 1.1 |

From the above table, it is suggested that the samples prepared from the polyurethane systems exhibited a long-lasting tensile strength even after aging tests in high temperature and high humidity level.

1. A polyester polyol, comprising a condensation product of:
a biobased C7-C12 dicarboxylic acid;
a biobased C2-C10 diol; and
a branched diol having the following formula: 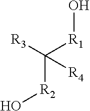
wherein R1 and R2 are independently a linear alkylene linkage having 1 to 3 carbon atoms, and R3 and R4 are independently an alkyl group having 1 to 3 carbon atoms, and wherein the weight ratio of the biobased C2-C10 diol to the branched diol is (25-53) to (47-75).

2. The polyester polyol according to claim 1, wherein the biobased C7-C12 dicarboxylic acid is suberic acid, azelaic acid, sebacic acid, dodecanedioic acid, cyclohexanedicarboxylic acid, terephthalic acid, or any mixture thereof.

3. The polyester polyol according to claim 1, wherein biobased C2-C10 diol is at least one selected from the group consisting of 1,3-propanediol, trans-2-butene-1,4-diol, 1,4-butanediol, 1,5-pentanediol, and 1,10-decanediol.

4. The polyester polyol according to claim 3, wherein the branched diol is neopentyl glycol, methyl propanediol, 2-ethyl-1,3-propanediol, 2,2,4-trimethylpentane-1,3-diol, or any mixture thereof.

5. The polyester polyol according to claim 1, wherein the polyester polyol has a number average molecular weight of 1,000 to 3,000 g/mol.

6. The polyester polyol according to claim 1, wherein the molar ratio of carboxylic groups in the biobased C7-C12 dicarboxylic acid and hydroxyl groups in both the biobased C2-C10 diol and the branched diol is 1:(1.02-1.20).

7. The polyester polyol according to claim 1, wherein the polyester polyol has a viscosity under 25° C. of 8,000 mPas to 13,000 mPas, measured according to DIN EN 3219.

8. The polyester polyol according to claim 1, wherein the polyester polyol has a biobased content higher than 60 wt. % according to the EN 16785-1 standard.

9. A polyurethane system comprising:
a polyol component; and
an isocyanate component,
wherein the polyol component comprises
the polyester polyol according to claim 1; and
one or more catalysts.

10. The polyurethane system according to claim 9, wherein the polyester polyol has a weight percentage of 50 wt. % to 100 wt. % based on a total weight of the polyol component.

11. The polyurethane system according to claim 9, further comprising a blowing agent.

12. The polyurethane system according to claim 9, wherein the polyol component and the isocyanate component are in a weight ratio such that an isocyanate index of the polyurethane system is from 80% to 500%.

13. A process of preparing a polyester polyol comprising:
(a) in a reaction vessel, mixing a biobased C7-C12 dicarboxylic acid, a biobased C2-C10 diol, and a branched diol, and obtaining a mixture;
(b) heating the mixture at a first temperature in a range of 180° C. to 250° C. for a first duration of time to form a crude product;
(c) heating the crude product at a second temperature in a range of 100° C. to 150° C. for a second duration of time in a range of 1 to 4 hours to form a second crude product; and
(d) isolating a polyester polyol from the second crude product, wherein the branched diol has the following formula: 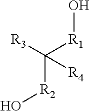
wherein R1 and R2 are independently a linear alkylene linkage having 1 to 3 carbon atoms, and R3 and R4 are independently an alkyl group having 1 to 3 carbon atoms.

14. The process of claim 13, wherein (b) comprises heating the mixture under a sub-atmospheric pressure in a range of 5 mbar to 0.8 bar.

15. The process of claim 13, wherein the first duration of time is 1 to 6 hour.
